(19) United States
(12) Patent Application Publication
(10) Pub. No.: US 2026/0031278 A1
(43) Pub. Date: Jan. 29, 2026

(54) DIELECTRIC CERAMIC ELECTRONIC DEVICE

(71) Applicant: TDK CORPORATION, Tokyo (JP)

(72) Inventors: Tomoyuki TANABE, Tokyo (JP); Atsushi WATANABE, Tokyo (JP); Kazuhiro OKADA, Tokyo (JP); Shizuku ITO, Tokyo (JP); Yasuhiro OKUI, Tokyo (JP); Toshihiro IGUCHI, Tokyo (JP)

(73) Assignee: TDK CORPORATION, Tokyo (JP)

(21) Appl. No.: 19/242,634

(22) Filed: Jun. 18, 2025

(30) Foreign Application Priority Data
Jul. 25, 2024 (JP) 2024-119661

(51) Int. Cl. H01G 4/30; H01G 4/012

(52) U.S. Cl. CPC H01G 4/30; H01G 4/012

(57) ABSTRACT

A dielectric ceramic electronic device includes a ceramic sintered body having a surface at least partly containing a dielectric. The surface of the ceramic sintered body has a base color with a chroma C* value in a range of 5 to 11 and a lightness L* value in a range of 38 to 50.

### TECHNICAL FIELD

The present invention relates to a dielectric ceramic electronic device.

### BACKGROUND

Known as an example of a dielectric ceramic electronic device is a multilayer ceramic capacitor described in, for example, Patent Document 1 shown below. When such a multilayer ceramic capacitor is manufactured, a dielectric material and an electrode material need to be fired simultaneously. Thus, due to, for example, a difference in linear expansion coefficients of these materials, cracks or the like may be generated at a surface of a ceramic sintered body depending on manufacturing conditions or the like; and the multilayer ceramic capacitor having cracks or the like needs to be eliminated as a defective product.

Other than cracks, the surface of the ceramic sintered body may have appearance defects, such as scratches and adhesion of foreign matter, caused in a manufacturing process. These appearance defects are detected by taking an image with a camera or the like; however, experiments by the present inventors have revealed that, depending on the materials of the ceramic sintered body, its manufacturing conditions, or the like, accurate detection of such defects may be difficult.
Patent Document 1: JP Patent Application Laid Open No. 2011-14940

### SUMMARY

The present invention has been achieved in view of such circumstances. It is an object of the invention to provide a dielectric ceramic electronic device including a ceramic sintered body whose appearance defects at its surface are easily detected.

To achieve the above object, a dielectric ceramic electronic device according to one aspect of the present invention is a dielectric ceramic electronic device including a ceramic sintered body having a surface at least partly containing a dielectric, wherein the surface of the ceramic sintered body has a base color with a chroma C* value in a range of 5 to 11 and a lightness L* value in a range of 38 to 50.

Chroma and lightness of the base color of the surface of the ceramic sintered body being within the above ranges enable appearance defects (e.g., cracks, scratches, and adhesion of foreign matter) at the surface of the sintered body to be readily detected. For example, a surface of a dielectric ceramic sintered body having a composition of (Ca,Sr)(Ti,Zr)O₃+subcomponent (e.g., MnCO₃, Al₂O₃, or SiO₂) readily has a gray base color in general, and the ability to detect cracks, scratches, foreign matter, or the like is readily decreased at that surface. In the dielectric ceramic electronic device according to the one aspect of the present invention, devising the V, Mn, etc. content, manufacturing conditions, or the like can control chroma and lightness of the base color within the above ranges. Consequently, appearance defects (e.g., cracks, scratches, and adhesion of foreign matter) at the surface of the sintered body are readily detected.

Preferably, the surface of the ceramic sintered body has a surface roughness Ra in a range of 0.07 to 0.56.

The ceramic sintered body may include electrode layers and dielectric layers inside, the electrode layers and the dielectric layers being alternately laminated; and surfaces of the ceramic sintered body may include main surfaces facing each other along a lamination direction of the electrode layers and side surfaces meeting the main surfaces substantially perpendicularly. In this situation, the lightness L* value of the base color of the main surfaces is preferably in a range of 40 to 50 whereas the lightness L* value of the base color of the side surfaces is preferably in a range of 38 to 48. The chroma C* value of the base color of the main surfaces is preferably in a range of 8 to 11 whereas the chroma C* value of the base color of the side surfaces is preferably in a range of 8 to 10.

The main surfaces and the side surfaces may have slightly different preferable ranges of lightness and slightly different preferable ranges of chroma despite being composed of the same dielectric using the same manufacturing method. For example, the lightness L* value of the base color of the main surfaces tends to be not less than that of the side surfaces; and the chroma C* value of the base color of the main surfaces tends to be not less than that of the side surfaces.

### BRIEF DESCRIPTION OF THE DRAWING(S)

FIG. 1 is a schematic perspective view of a dielectric ceramic electronic device according to one embodiment of the present invention.

FIG. 2A is a schematic sectional view of the dielectric ceramic electronic device along a line IIA-IIA shown in FIG. 1.

FIG. 2B is a schematic sectional view of the dielectric ceramic electronic device along a line IIB-IIB shown in FIG. 1.

FIG. 3 is a schematic diagram of a relationship between lightness and chroma of a base color.

### DETAILED DESCRIPTION

Hereinafter, an embodiment is described.

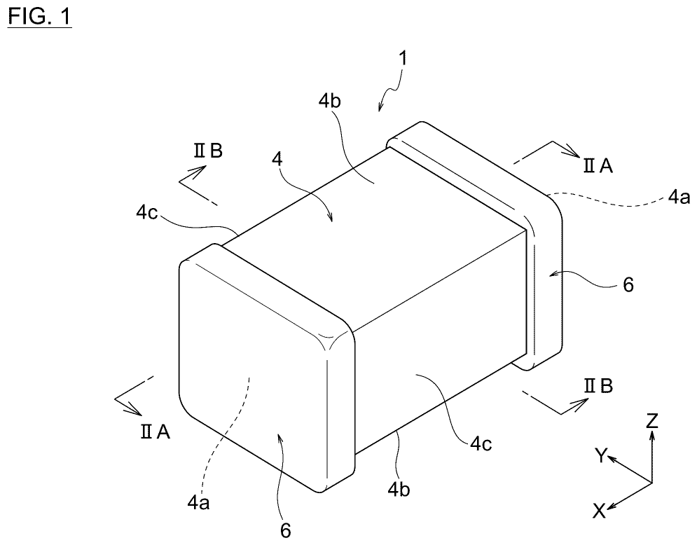

As shown in FIG. 1, a multilayer ceramic capacitor 1 as an example of a dielectric ceramic electronic device according to the embodiment includes an element body 4 composed of a ceramic sintered body having a substantially rectangular parallelepiped shape (substantially hexahedral shape).

The element body 4 includes a pair of end surfaces 4a substantially perpendicular to the X-axis, a pair of main surfaces 4b substantially perpendicular to the Z-axis, and a pair of side surfaces 4c substantially perpendicular to the Y-axis. The element body 4 may have any dimensions. The dimensions are appropriately determined according to a use. The element body 4 can have, for example, a length of 0.3 mm to 5.7 mm in the X-axis direction, a width of 0.3 mm to 5.0 mm in the Y-axis direction, and a height of 0.3 mm to 3.0 mm in the Z-axis direction. In the present embodiment, the X-axis, the Y-axis, and the Z-axis are perpendicular to each other. The end surfaces 4a, which are located opposite each other along the X-axis of the element body 4, are provided with respective external electrodes 6.

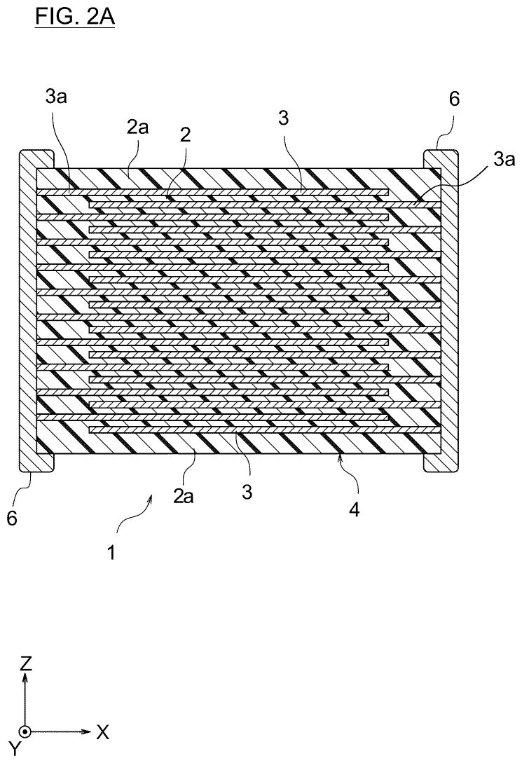

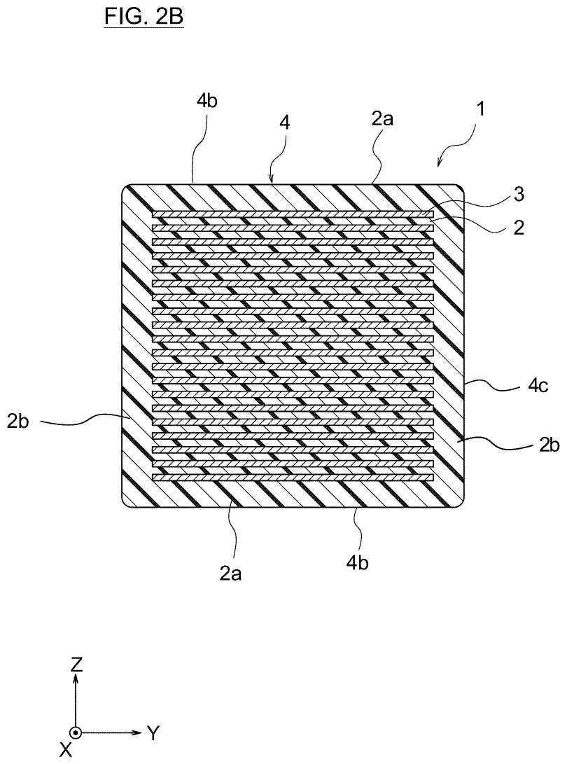

The element body 4 is, as shown in FIGS. 2A and 2B, a dielectric ceramic sintered body composed of a laminate including inner dielectric layers 2 and internal electrode layers 3 alternately laminated. The internal electrode layers 3 are laminated so that one end of each layer is exposed alternately to one of the two end surfaces 4a of the element body 4.

In the present embodiment, the one end of each internal electrode layer 3 drawn out to the corresponding end surface 4a is called a leadout portion 3a. An exposed end of the leadout portion 3a is electrically connected to the external electrode 6 covering the end surface 4a. The internal electrode layers 3 are laminated so as to alternately have different polarities along the lamination direction. Such a structure provides a capacitor circuit incorporating the internal electrode layers 3 and the external electrodes 6.

The external electrodes 6 are provided so as to cover the respective end surfaces 4a and to extend therefrom to part of the main surfaces 4b and part of the side surfaces 4c. The external electrodes 6 are electrically insulated from each other. The external electrodes 6 have conductivity and may be composed of any material or have any thickness. The external electrodes 6 may include a single layer or a plurality of layers. The external electrodes 6 can be, for example, multilayer electrodes each including a baked electrode (sintered electrode), a resin electrode, and a plating layer.

As shown in FIG. 2B, inside the element body 4, at both sides of the inner dielectric layers 2 and the internal electrode layers 3 of the laminate along the Z-axis, outer dielectric layers 2a are laminated. Also, inside the element body 4, at both sides of the inner dielectric layers 2 and the internal electrode layers 3 of the laminate along the Y-axis, margin portions 2b are provided.

In the present embodiment, the outer dielectric layers 2a are composed of a dielectric that is the same as or different from that of the inner dielectric layers 2; and outer surfaces of the outer dielectric layers 2a constitute the main surfaces 4b of the element body 4. The margin portions 2b are composed of a dielectric that is the same as or different from that of the inner dielectric layers 2; and outer surfaces of the margin portions 2b constitute the side surfaces 4c of the element body 4.

In the present embodiment, the number of the inner dielectric layers 2 is not limited. The number of the inner dielectric layers 2 may be, for example, 20 or more or 50 or more. The number of the internal electrode layers 3 is determined according to the number of the inner dielectric layers 2. The inner dielectric layers 2 may have any average thickness. The average thickness of the inner dielectric layers 2 can be, for example, 0.5 μm to 100 μm or can be 10 μm or less, 5 μm or less, 2.5 μm or less, or 1 μm or less. The internal electrode layers 3 may also have any average thickness. The average thickness of the internal electrode layers 3 can be, for example, 0.5 μm to 10 μm or can be 5 μm or less, 2.5 μm or less, or 1 μm or less.

The dielectrics constituting the inner dielectric layers 2, the outer dielectric layers 2a, and the margin portions 2b may be the same or different. In the present embodiment, they are composed of a dielectric composition containing a predetermined subcomponent.

The dielectric composition contains a main component that may be a paraelectric or a ferroelectric. The main component can be, for example, a dielectric ceramic having a perovskite type crystal structure or a dielectric ceramic having a tungsten bronze type crystal structure. Examples of dielectric ceramics having a perovskite structure include (Ba, Ca)(Ti, Zr)O₃ (e.g., barium titanate), (Ca, Sr)(Ti, Zr)O₃ (e.g., calcium titanate and strontium titanate), (K, Na)NbO₃, and (Bi, Na)TiO₃. Examples of dielectric ceramics having a tungsten bronze structure include Ba(Nb, Ta)₂O₆, Ca(Nb, Ta)₂O₆, (K, Na)Sr₂Nb₅O₁₅, Ba₃TiNb₄O₁₅, and Ba₂LaTi₂Nb₃O₁₅.

The main component of the dielectric preferably includes Ca and/or Sr and Zr or more preferably includes a perovskite type compound represented by a formula ABO₃. In this context, the main component denotes a component, composed of the main component's constituent elements, constituting a total of 80 parts by mol or more out of a total of 100 parts by mol of all constituent elements of the dielectric. In the present embodiment, the A-site of the perovskite type compound preferably includes at least Ca and Sr; or the perovskite type compound is more preferably a compound that can be represented by a composition formula (Ca₁₋ₓSrₓ)ₘ(Zr_{1-y-z}Ti_{y}Hf₂)O₃ (hereinafter referred to as a CSZT based compound). In the composition formula, x, y, z, and m are elemental ratios. The elemental ratios are not limited and can be determined within known ranges.

For example, m represents the elemental ratio of the A-site to the B-site and can normally range from 0.9 to 1.1. Also, x represents the elemental ratio of Sr in the A-site and can satisfy 0≤x≤1. That is, the ratio of Ca to Sr is determined freely; and it may be that only either of them is contained.

Also, y represents the elemental ratio of Ti in the B-site, and z represents the elemental ratio of Hf in the B-site. That is, 1−y−z represents the elemental ratio of Zr in the B-site. In the present embodiment, 0.80≤1−y−z≤1.0 is preferably satisfied. In a situation where the elemental ratio of Zr is within the above range, high-temperature load life at a high voltage is improved, and the crack occurrence rate can further be decreased.

The elemental ratio of oxygen (O) in the above composition formula may slightly deviate from the stoichiometric composition.

Other than the above main component, the dielectric may also contain a subcomponent. Examples of subcomponents include a Mn compound, a V compound, a Cr compound, a Si compound, an Al compound, a Mg compound, a Ni compound, a Li compound, and a B compound. There is no limit to the type, combination, or content of the subcomponents.

The internal electrode layers 3, as part of the capacitor circuit, perform a function to apply a voltage to the inner dielectric layers 2. Thus, the internal electrode layers 3 include a conductive material. Specifically, the conductive material of the internal electrode layers 3 can be composed of a base metal (e.g., Cu or Ni), a noble metal (e.g., Ag, Pd, Au, or Pt), or an alloy containing at least one of these metal elements. More preferably, the conductive material of the internal electrode layers 3 is Ni or a Ni based alloy, because a constituent material of the inner dielectric layers 2 has resistance to reduction. In a situation where a Ni based alloy is used as the conductive material, the Ni based alloy preferably contains at least one subcomponent selected from Mn, Cr, Co, and Al. The Ni based alloy has a Ni content of preferably 95 wt % or more.

The internal electrode layers 3 may contain, as an inhibitor, a ceramic component of the inner dielectric layers 2 other than the above conductive material. The internal electrode layers 3 may also contain a slight amount (e.g., 0.1 wt % or less) of non-metal components, such as S and P.

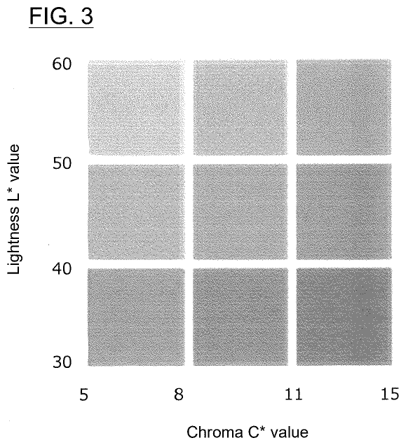

In the present embodiment, the main surfaces 4b and the side surfaces 4c of the element body 4, which is composed of the dielectric ceramic sintered body, have a base color with a chroma C* value in a range of 5 to 11 and a lightness L* value in a range of 38 to 50. The chroma C* value and the lightness L* value of the base color can be measured based on, for example, JIS Z 8781-6:2017. FIG. 3 is a schematic diagram of an example of a relationship between the lightness L* value and the chroma C* value. The higher the lightness L* numerical value, the lighter the color; and the higher the chroma C* numerical value, the brighter the color.

Chroma and lightness of the base color of the main surfaces 4b and the side surfaces 4c of the element body 4 being within the above ranges enable appearance defects (e.g., cracks, scratches, and adhesion of foreign matter) at the surfaces (the main surfaces 4b and the side surfaces 4c) of the element body 4 to be readily detected. For example, a surface of a dielectric ceramic sintered body having a composition of (Ca, Sr)(Ti, Zr)O₃+subcomponent (e.g., MnCO₃, Al₂O₃, or SiO₂) readily has a gray base color in general, and the ability to detect cracks, scratches, foreign matter, or the like is readily decreased at that surface. In the dielectric constituting the surfaces of the element body 4 according to the present embodiment, devising the V, Mn, etc. content, manufacturing conditions, or the like can control chroma and lightness of the base color within the above ranges. Consequently, appearance defects (e.g., cracks, scratches, and adhesion of foreign matter) at the surfaces of the element body 4 are readily detected.

The surfaces of the element body 4 have a surface roughness Ra in a range of preferably 0.07 to 0.56. The surface roughness Ra can be measured based on, for example, JIS B 0601-2001. The surface roughness Ra of the surfaces of the element body 4 being within the predetermined range enables appearance defects (e.g., cracks, scratches, and adhesion of foreign matter) at the surfaces of the element body 4 to be readily detected. The surface roughness Ra of the surfaces of the element body 4 can be controlled by, for example, changing treatment time, treatment conditions, or the like of barrel polishing of the element body 4 prior to formation of the external electrodes 6 and 6.

In the present embodiment, the main surfaces 4b and the side surfaces 4c may have different preferable ranges of lightness and different preferable ranges of chroma. Preferably, for example, the lightness L* value of the base color of the main surfaces 4b is in a range of 40 to 50 whereas the lightness L* value of the base color of the side surfaces is in a range of 38 to 48. Preferably, the chroma C* value of the base color of the main surfaces 4b is in a range of 8 to 11 whereas the chroma C* value of the base color of the side surfaces 4c is in a range of 8 to 10.

In the present embodiment, the main surfaces 4b and the side surfaces 4c are composed of the same dielectric. The main surfaces 4b and the side surfaces 4c may have slightly different preferable ranges of lightness and slightly different preferable ranges of chroma despite their manufacturing methods being the same. For example, the lightness L* value of the base color of the main surfaces 4b tends to be not less than that of the side surfaces 4c, and the chroma C* value of the base color of the main surfaces 4b tends to be not less than that of the side surfaces 4c.

The multilayer ceramic capacitor 1 of the present embodiment can be manufactured by preparing a green chip with a printing method or a sheet method using a paste, firing the green chip, and then forming the pair of external electrodes 6 on the resultant laminate. Detailed description of the manufacturing method follows.

First, steps of manufacturing the element body 4 are described. In the steps of manufacturing the element body 4, a dielectric paste to be the inner dielectric layers 2 and the outer dielectric layers 2a after firing and an internal electrode paste to be the internal electrode layers 3 after firing are prepared.

The dielectric paste is prepared, for example, as follows. First, dielectric raw materials are uniformly mixed using, for example, wet-mixing and are dried. Then, the resultant mixture is subject to a heat treatment under predetermined conditions to give a calcined powder. Then, to the resultant calcined powder, a known organic vehicle or a known water based vehicle is added; and this mixture is kneaded to give the dielectric paste.

The dielectric paste obtained in this manner is turned into sheets using, for example, a doctor blade method to give ceramic green sheets. The dielectric paste may contain additives selected from various dispersants, plasticizers, dielectrics, subcomponent compounds, glass frit, and the like as necessary.

The internal electrode paste is prepared by kneading a metal material and a known binder or solvent.

Then, the internal electrode paste is applied to the ceramic green sheets in a predetermined pattern using a printing method (e.g., screen printing) or a transfer method to form internal electrode patterns.

The ceramic green sheets with the internal electrode patterns are laminated and are then pressed in the lamination direction to give a mother laminate. At this time, the ceramic green sheets and the internal electrode patterns are laminated so that the ceramic green sheets are located at an upper surface and a lower surface of the mother laminate in the lamination direction.

The mother laminate obtained through the above steps is cut into predetermined dimensions by dicing or push-cutting to give green chips. As necessary, the green chips may be subject to solidification drying to remove plasticizers or the like and may then be subject to barrel polishing using a horizontal centrifugal barrel machine or the like. In barrel polishing, the green chips are put into a barrel together with media and a polishing liquid, and a rotational movement or vibration is applied to the barrel. This removes unwanted parts (e.g., burrs generated during cutting). The green chips after barrel polishing are washed with a cleaning liquid (e.g., water) and are dried.

Then, each of the resultant green chips is subject to a binder removal treatment and a firing treatment to give the element body 4. Conditions of the binder removal treatment are appropriately determined according to the composition of the main component of the inner dielectric layers 2 or the composition of the main component of the internal electrode layers 3 and are not limited. For example, the heating rate is preferably 5° C./hour to 300° C./hour; the holding temperature is preferably 180° C. to 400° C.; and the temperature holding time is preferably 0.5 hours to 24 hours. The binder removal atmosphere is air or a reducing atmosphere.

Conditions of the firing treatment are appropriately determined according to the composition of the main component of the inner dielectric layers 2 or the composition of the main component of the internal electrode layers 3 and are not limited. For example, the holding temperature during firing is preferably 1200° C. to 1400° C. or is more preferably 1220° C. to 1300° C.; the holding time during firing is preferably 0.5 hours to 8 hours or is more preferably 1 hour to 3 hours; and the heating rate and the cooling rate are preferably 50° C./hour to 500° C./hour. The firing atmosphere is preferably a reducing atmosphere. As an ambient gas, for example, a humidified mixed gas of N₂ and H₂ can be used. Further, in a situation where the internal electrode layers 3 are composed of a base metal (e.g., Ni or a Ni based alloy), the oxygen partial pressure of the firing atmosphere is preferably 2.0×10⁻¹³ atm to 1.0×10⁻⁷ atm.

After firing, the resultant element body 4 may be subject to a reoxidation treatment (annealing) as necessary. As for annealing conditions, for example, the oxygen partial pressure of annealing is preferably higher than that of firing, and the holding temperature is preferably 1150° C. or less.

In the binder removal treatment, the firing treatment, and the annealing treatment described above, for example, a wetter is used to humidify the N₂ gas, the mixed gas, or the like. In this situation, the water temperature is preferably about 5° C. to about 75° C. The binder removal treatment, the firing treatment, and the annealing treatment may be carried out continuously or independently.

End surfaces of the element body 4 obtained in the above manner are polished, and an external electrode paste is applied there and is baked to form the external electrodes 6. On surfaces of the external electrodes 6, a coating layer is formed by plating or the like as necessary.

The above steps give the multilayer ceramic capacitor 1 including the external electrodes 6. In manufacture of the element body 4, which is the dielectric ceramic sintered body, devising the V, Mn, Cr, Ti, etc. content, manufacturing conditions of the element body 4, or the like controls chroma and lightness of the base color of the main surfaces 4b and the side surfaces 4c within the ranges described above.

Changing, for example, at least one of the V content, the Mn content, the Cr content, the Ti content, and the like as raw material powders of the dielectric can change lightness and chroma as follows. For example, increasing the V content from its standard value tends to decrease the numerical value of lightness and increase the numerical value of chroma. Increasing the Mn content from its standard value tends to decrease the numerical value of lightness and decrease the numerical value of chroma. Increasing the Cr content from its standard value tends to decrease the numerical value of lightness and increase the numerical value of chroma. Increasing the Ti content from its standard value tends to decrease the numerical value of lightness and decrease the numerical value of chroma.

Also, decreasing the particle sizes of the raw material powders of the dielectric from their standard values tends to decrease the numerical value of lightness and tends not to change the numerical value of chroma.

Moreover, increasing the time during which the maximum firing temperature is maintained during firing of the element body from its standard value tends to decrease the numerical value of lightness and tends not to change the numerical value of chroma. Increasing the heating rate of the element body until the maximum firing temperature is reached during firing from its standard value tends to increase the numerical value of lightness and tends not to change the numerical value of chroma. Increasing the temperature of the annealing treatment after the element body is fired from its standard value tends not to change the numerical value of lightness and tends to increase the numerical value of chroma.

In the present embodiment, the standard value of at least one of the V content, the Mn content, the Cr content, the Ti content, and the like is, for example, 0.2 to 1 wt %. In a situation where the at least one is increased or decreased, the increase or decrease is preferably within 10% at maximum from the standard value. The standard value of the particle sizes of the raw material powders of the dielectric is, for example, d50=0.4 to 0.6 μm. In a situation where the particle sizes of the raw material powders of the dielectric are increased or decreased, the increase or decrease is preferably within 80% at maximum from the standard value.

The standard value of the time during which the maximum firing temperature is maintained is, for example, 100 to 130 minutes. In a situation where the time is increased or decreased, the increase or decrease is preferably within 80% at maximum from the standard value. The standard value of the heating rate is, for example, 100° C./hr to 300° C./hr. In a situation where the heating rate is increased or decreased, the increase or decrease is preferably within 80% at maximum from the standard value. The standard value of the annealing temperature is, for example, 600° C. to 1000° C. In a situation where the annealing temperature is increased or decreased, the increase or decrease is preferably within 80% at maximum from the standard value.

Combining such conditions can control chroma and lightness of the base color of the main surfaces 4b and the side surfaces 4c within the ranges described above.

The resultant multilayer ceramic capacitor 1 can be surface-mounted on a substrate (e.g., a printed wiring board) using solder (including molten solder, solder cream, and a solder paste) or a conductive adhesive and is included in various electronics. Alternatively, the multilayer ceramic capacitor 1 can be mounted on a substrate using a wire-shaped lead terminal or a plate-shaped metal terminal. Alternatively, a circuit substrate can have the multilayer ceramic capacitor 1 built-in.

The multilayer ceramic capacitor 1 of the present embodiment satisfies COG characteristics specified by JIS standards CH and, moreover, achieves a high specific resistance and excellent high-temperature load life. The multilayer ceramic capacitor 1 demonstrates excellent insulation properties even in a situation where, in particular, the multilayer ceramic capacitor 1 is exposed to a high-temperature environment that is 200° C. or more.

Furthermore, at the time of appearance inspection of the multilayer ceramic capacitor 1 of the present embodiment after it is manufactured, appearance defects (e.g., cracks, scratches, and adhesion of foreign matter) at the surfaces of the element body are readily detected.

The present invention is not limited to the above embodiment and can be variously modified within the scope of the present invention.

For example, at least either of the outer dielectric layers 2a and 2a shown in FIG. 2B may be covered with a transparent glass layer. The margin portions 2b are not necessarily composed of a dielectric and may be composed of, for example, a transparent or nontransparent glass material. Dielectric ceramic electronic devices are not limited only to the multilayer ceramic capacitor 1. They may be other electronic devices in which at least a part of a surface of a ceramic sintered body composed of a dielectric is externally observed.

### EXAMPLES

Hereinafter, more detailed examples are described; however, the present invention is not limited to these examples.

### Example 1

First, as starting raw materials for manufacturing a dielectric oxide, SrCO₃, CaCO₃, TiO₂, ZrO₂, and HfO₂ having an average particle size of d50=0.4 μm were prepared. Then, the prepared starting raw materials were weighed and were mixed at a weight ratio at which the final composition would be [(Ca_{0.7}Sr_{0.3})O][(Ti_{0.03}Zr_{0.92}Hf_{0.05})O₂] to prepare a pre-calcination mixture.

The resultant pre-calcination mixture was calcined to give the dielectric oxide having the above composition. Calcination conditions were as follows. The heating rate was 200° C./hour. The holding temperature was 1200° C. The temperature holding time was 2 hours. The atmosphere was air. Then, the resultant dielectric oxide was pulverized using an alumina roll crusher.

Then, as sintering aid, a mixture of MnO, Al₂O₃, and SiO₂ was prepared and was added to 100 parts by weight of the above dielectric oxide at a predetermined ratio (as for MnO, 0.2 wt % as shown in Table 1A). Further, with the resultant mixture, 4.8 parts by weight acrylic resin, 40 parts by weight methylene chloride, 20 parts by weight ethyl acetate, 6 parts by weight mineral spirits, and 4 parts by weight acetone were mixed using a ball mill; and the mixture was turned into a paste to give a dielectric paste.

100 parts by weight Ni particles having an average particle size of 0.1 to 0.8 μm, 40 parts by weight organic vehicle (mixture of 92 parts by weight butyl carbitol and 8 parts by weight ethyl cellulose dissolved therein), and 10 parts by weight butyl carbitol were kneaded using a triple-roll mill and were turned into a paste to give an internal electrode paste.

100 parts by weight Cu particles having an average particle size of 0.5 μm, 35 parts by weight organic vehicle (mixture of 92 parts by weight butyl carbitol and 8 parts by weight ethyl cellulose resin dissolved therein), and 7 parts by weight butyl carbitol were kneaded and were turned into a paste to give an external electrode paste.

Using the above dielectric paste, green sheets having a thickness of 7 μm were formed on PET films. On the green sheets, the internal electrode paste was printed, and the green sheets were peeled off from the PET films.

These green sheets and exterior green sheets (for outer dielectric layers on which the internal electrode paste was not printed) were laminated and were pressed to give a green chip. The number of the laminated sheets having internal electrodes was 101.

The green chip was then cut into a predetermined size. The resultant chips were subject to a binder removal treatment, firing, and annealing to give multilayer ceramic sintered bodies. As shown in the table, the maximum temperature during firing was 1230° C.; the maintaining time (keeping time) was 90 minutes; the heating rate was 400° C./hr; and the annealing temperature was 700° C.

Then, end surfaces of the multilayer ceramic sintered bodies were polished using sandblasting. To the end surfaces, the external electrode paste was transferred. Firing was carried out at 800° C. for 10 minutes in a humidified N₂+H₂ atmosphere to form external electrodes. This gave multilayer ceramic capacitor samples. Each of the resultant samples had a size of 3.2 mm×1.6 mm×0.6 mm. The number of dielectric layers between internal electrode layers was 100. The dielectric layers had a thickness of 4.9 μm. The internal electrode layers had a thickness of 0.2 μm.

The lightness L* value and the chroma C* value of the base color of main surfaces 4b and side surfaces 4c of an element body 4 of each sample were found based on JIS Z 8781-6:2017. The values were measured in the vicinity of a center of one main surface 4b or in the vicinity of a center of one side surface 4c. Measurements of ten samples were averaged. Table 1B shows the results.

Surface roughness Ra of the main surfaces 4b and the side surfaces 4c of the samples were found based on JIS B 0601-2001. Surface roughness was measured in the vicinity of a center of one main surface 4b or in the vicinity of a center of one side surface 4c. Measurements of ten samples were averaged. Table 1B shows the results.

Among the resultant product samples, one thousand samples having good appearance were prepared. One hundred samples among them were subject to a heat treatment, a pressure cooker test (PCT), or the like to generate cracks. Another one hundred among them were scratched at their chip surfaces using a scribing pen. As for still another one hundred among them, a small amount of Fe powder was sprinkled over surfaces of the green chips, and firing was carried out (at 700° C. for 1 hour) to prepare samples having foreign matter. The remaining seven hundred samples were used as samples having good appearance.

These samples prepared in such a manner were subject to appearance inspection by the same appearance inspector. Samples whose crack detection rate, scratch detection rate, and foreign matter detection rate were all 95% or more were deemed “good”. Table 1C shows the detection rates of the various defects (cracks, scratches, and foreign matter).

### Examples 2 to 4

Multilayer ceramic capacitor samples were manufactured as in Example 1 except that the keeping time and/or the heating rate was changed as shown in Table 1A. Measurement was carried out as in Example 1. Tables 1B and 1C show the results.

### Comparative Examples 1 to 8

Multilayer ceramic capacitor samples were manufactured as in Examples 1 to 4 except that the particle size of the dielectric raw materials was changed as shown in Table 1A. Measurement was carried out as in Example 1. Tables 1B and 1C show the results.

### Comparative Examples 9 to 11 and Example 5

Multilayer ceramic capacitor samples were manufactured as in Examples 1 to 4 except that the particle size of the dielectric raw materials and the firing temperature were changed as shown in Table 1A. Measurement was carried out as in Example 1. Tables 1B and 1C show the results.

### Examples 6 to 9

Multilayer ceramic capacitor samples were manufactured as in Examples 1 to 4 except that the particle size of the dielectric raw materials and the firing temperature were changed as shown in Table 1A. Measurement was carried out as in Example 1. Tables 1B and 1C show the results.

### Example 10 and Comparative Examples 12 to 14

Multilayer ceramic capacitor samples were manufactured as in Examples 1 to 4 except that the firing temperature was changed as shown in Table 1A. Measurement was carried out as in Example 1. Tables 1B and 1C show the results.

### Examples 11 to 14

Multilayer ceramic capacitor samples were manufactured as in Examples 1 to 4 except that the particle size of the dielectric raw materials and the firing temperature were changed as shown in Table 1A. Measurement was carried out as in Example 1. Tables 1B and 1C show the results.

### Example 15 and Comparative Examples 15 to 17

Multilayer ceramic capacitor samples were manufactured as in Examples 1 to 4 except that the particle size of the dielectric raw materials and the firing temperature were changed as shown in Table 1A. Measurement was carried out as in Example 1. Tables 1B and 1C show the results.

### Comparative Examples 18 to 21

Multilayer ceramic capacitor samples were manufactured as in Examples 1 to 4 except that the firing temperature was changed as shown in Table 1A. Measurement was carried out as in Example 1. Tables 1B and 1C show the results.

### Example 16 and Comparative Examples 22 to 27

Multilayer ceramic capacitor samples were manufactured as in Example 2, 7, or 12 except that V was added, the Mn content was changed, and the annealing temperature was changed as shown in Table 2A. Measurement was carried out as in Example 1. Tables 2B and 2C show the results.

### Examples 17 and 18

Multilayer ceramic capacitor samples were manufactured as in Example 2 except that a sandblasting treatment for the element bodies was carried out before the external electrodes were formed to control the surface roughness of the main surfaces 4b and the side surfaces 4c as shown in Table 3B. Measurement was carried out as in Example 1. Tables 3B and 3C show the results.

### Evaluation 1

According to the results shown in Tables 1A to 1C and Tables 2A to 2C, it was found that, in each Example in which chroma C* and lightness L* of the main surfaces and the side surfaces satisfied predetermined ranges, the detection rates of cracks, scratches, and foreign matter were all 96% or more, which was higher than those of Comparative Examples. It was also found that chroma C* of the main surfaces was preferably in a range of 8 to 11, that lightness L* of the main surfaces was preferably in a range of 40 to 50, that chroma C* of the side surfaces was preferably in a range of 8 to 10, and that lightness L* of the side surfaces was preferably in a range of 38 to 48.

### Evaluation 2

According to the results shown in Tables 3A to 3C, it was found that the surface roughness of the main surfaces and the side surfaces may be in a range of 0.07 to 0.56. According to the results shown in Tables 1A to 2C, it was found that the surface roughness of the main surfaces and the side surfaces may be in a range of 0.14 to 0.47.

TABLE 1A

| | Firing | Particle | Keeping | Heating | Annealing | Content | |
|---|---|---|---|---|---|---|---|
| | temperature | size | time | rate | temperature | [wt %] | |
| Level | [° C.] | [μm] | [min] | [° C./hr] | [° C.] | V | Mn |
| Comparative | 1,230 | 0.7 | 90 | 400 | 700 | 0 | 0.2 |
| Example 1 | | | | | | | |
| Comparative | 1,230 | 0.7 | 90 | 80 | 700 | 0 | 0.2 |
| Example 2 | | | | | | | |
| Comparative | 1,230 | 0.7 | 150 | 400 | 700 | 0 | 0.2 |
| Example 3 | | | | | | | |
| Comparative | 1,230 | 0.7 | 150 | 80 | 700 | 0 | 0.2 |
| Example 4 | | | | | | | |
| Comparative | 1,230 | 0.5 | 90 | 400 | 700 | 0 | 0.2 |
| Example 5 | | | | | | | |
| Comparative | 1,230 | 0.5 | 90 | 80 | 700 | 0 | 0.2 |
| Example 6 | | | | | | | |
| Comparative | 1,230 | 0.5 | 150 | 400 | 700 | 0 | 0.2 |
| Example 7 | | | | | | | |
| Comparative | 1,230 | 0.5 | 150 | 80 | 700 | 0 | 0.2 |
| Example 8 | | | | | | | |
| Example 1 | 1,230 | 0.3 | 90 | 400 | 700 | 0 | 0.2 |
| Example 2 | 1,230 | 0.3 | 90 | 80 | 700 | 0 | 0.2 |
| Example 3 | 1,230 | 0.3 | 150 | 400 | 700 | 0 | 0.2 |
| Example 4 | 1,230 | 0.3 | 150 | 80 | 700 | 0 | 0.2 |
| Comparative | 1,240 | 0.7 | 90 | 400 | 700 | 0 | 0.2 |
| Example 9 | | | | | | | |
| Comparative | 1,240 | 0.7 | 90 | 80 | 700 | 0 | 0.2 |
| Example 10 | | | | | | | |
| Comparative | 1,240 | 0.7 | 150 | 400 | 700 | 0 | 0.2 |
| Example 11 | | | | | | | |
| Example 5 | 1,240 | 0.7 | 150 | 80 | 700 | 0 | 0.2 |
| Example 6 | 1,240 | 0.5 | 90 | 400 | 700 | 0 | 0.2 |
| Example 7 | 1,240 | 0.5 | 90 | 80 | 700 | 0 | 0.2 |
| Example 8 | 1,240 | 0.5 | 150 | 400 | 700 | 0 | 0.2 |
| Example 9 | 1,240 | 0.5 | 150 | 80 | 700 | 0 | 0.2 |
| Example 10 | 1,240 | 0.3 | 90 | 400 | 700 | 0 | 0.2 |
| Comparative | 1,240 | 0.3 | 90 | 80 | 700 | 0 | 0.2 |
| Example 12 | | | | | | | |
| Comparative | 1,240 | 0.3 | 150 | 400 | 700 | 0 | 0.2 |
| Example 13 | | | | | | | |
| Comparative | 1,240 | 0.3 | 150 | 80 | 700 | 0 | 0.2 |
| Example 14 | | | | | | | |
| Example 11 | 1,250 | 0.7 | 90 | 400 | 700 | 0 | 0.2 |
| Example 12 | 1,250 | 0.7 | 90 | 80 | 700 | 0 | 0.2 |
| Example 13 | 1,250 | 0.7 | 150 | 400 | 700 | 0 | 0.2 |
| Example 14 | 1,250 | 0.7 | 150 | 80 | 700 | 0 | 0.2 |
| Example 15 | 1,250 | 0.5 | 90 | 400 | 700 | 0 | 0.2 |
| Comparative | 1,250 | 0.5 | 90 | 80 | 700 | 0 | 0.2 |
| Example 15 | | | | | | | |
| Comparative | 1,250 | 0.5 | 150 | 400 | 700 | 0 | 0.2 |
| Example 16 | | | | | | | |
| Comparative | 1,250 | 0.5 | 150 | 80 | 700 | 0 | 0.2 |
| Example 17 | | | | | | | |
| Comparative | 1,250 | 0.3 | 90 | 400 | 700 | 0 | 0.2 |
| Example 18 | | | | | | | |
| Comparative | 1,250 | 0.3 | 90 | 80 | 700 | 0 | 0.2 |
| Example 19 | | | | | | | |
| Comparative | 1,250 | 0.3 | 150 | 400 | 700 | 0 | 0.2 |
| Example 20 | | | | | | | |
| Comparative | 1,250 | 0.3 | 150 | 80 | 700 | 0 | 0.2 |
| Example 21 | | | | | | | |

TABLE 1B

| | Main surface | | | Side surface | | |
|---|---|---|---|---|---|---|
| | | | Surface | | | Surface |
| | | | roughness | | | roughness |
| | Chroma | Lightness | Ra | Chroma | Lightness | Ra |
| Level | C* | L* | [μm] | C* | L* | [μm] |
| Comparative | 8 | 60 | 0.42 | 5 | 58 | 0.22 |
| Example 1 | | | | | | |
| Comparative | 9 | 58 | 0.49 | 7 | 56 | 0.18 |
| Example 2 | | | | | | |
| Comparative | 9 | 57 | 0.36 | 7 | 55 | 0.13 |
| Example 3 | | | | | | |
| Comparative | 10 | 56 | 0.35 | 9 | 54 | 0.42 |
| Example 4 | | | | | | |
| Comparative | 8 | 57 | 0.40 | 8 | 55 | 0.48 |
| Example 5 | | | | | | |
| Comparative | 8 | 55 | 0.49 | 8 | 53 | 0.27 |
| Example 6 | | | | | | |
| Comparative | 11 | 53 | 0.34 | 9 | 51 | 0.34 |
| Example 7 | | | | | | |
| Comparative | 10 | 52 | 0.33 | 9 | 50 | 0.19 |
| Example 8 | | | | | | |
| Example 1 | 11 | 49 | 0.26 | 9 | 48 | 0.40 |
| Example 2 | 8 | 47 | 0.25 | 8 | 46 | 0.26 |
| Example 3 | 10 | 47 | 0.37 | 10 | 45 | 0.47 |
| Example 4 | 9 | 45 | 0.33 | 9 | 43 | 0.22 |
| Comparative | 9 | 55 | 0.38 | 9 | 53 | 0.13 |
| Example 9 | | | | | | |
| Comparative | 10 | 53 | 0.40 | 9 | 51 | 0.43 |
| Example 10 | | | | | | |
| Comparative | 8 | 52 | 0.22 | 8 | 50 | 0.30 |
| Example 11 | | | | | | |
| Example 5 | 9 | 50 | 0.25 | 9 | 48 | 0.24 |
| Example 6 | 10 | 45 | 0.33 | 9 | 44 | 0.33 |
| Example 7 | 11 | 43 | 0.24 | 10 | 42 | 0.27 |
| Example 8 | 10 | 42 | 0.30 | 9 | 41 | 0.21 |
| Example 9 | 8 | 41 | 0.46 | 8 | 40 | 0.14 |
| Example 10 | 9 | 40 | 0.22 | 9 | 38 | 0.26 |
| Comparative | 11 | 39 | 0.46 | 9 | 37 | 0.21 |
| Example 12 | | | | | | |
| Comparative | 10 | 37 | 0.36 | 9 | 35 | 0.33 |
| Example 13 | | | | | | |
| Comparative | 8 | 35 | 0.20 | 7 | 34 | 0.36 |
| Example 14 | | | | | | |
| Example 11 | 8 | 44 | 0.41 | 8 | 42 | 0.32 |
| Example 12 | 11 | 42 | 0.21 | 10 | 41 | 0.43 |
| Example 13 | 9 | 43 | 0.36 | 9 | 40 | 0.36 |
| Example 14 | 9 | 41 | 0.45 | 9 | 39 | 0.27 |
| Example 15 | 8 | 40 | 0.40 | 8 | 38 | 0.23 |
| Comparative | 10 | 37 | 0.38 | 9 | 35 | 0.39 |
| Example 15 | | | | | | |
| Comparative | 8 | 35 | 0.11 | 7 | 34 | 0.41 |
| Example 16 | | | | | | |
| Comparative | 9 | 35 | 0.14 | 8 | 32 | 0.26 |
| Example 17 | | | | | | |
| Comparative | 11 | 36 | 0.17 | 8 | 34 | 0.18 |
| Example 18 | | | | | | |
| Comparative | 8 | 35 | 0.31 | 6 | 33 | 0.37 |
| Example 19 | | | | | | |
| Comparative | 9 | 35 | 0.26 | 7 | 32 | 0.39 |
| Example 20 | | | | | | |
| Comparative | 8 | 33 | 0.47 | 6 | 31 | 0.33 |
| Example 21 | | | | | | |

TABLE 1C

| | Main surface | | | Side surface | | |
|---|---|---|---|---|---|---|
| | Crack | Scratch | Foreign matter | Crack | Scratch | Foreign matter |
| | detection | detection | detection | detection | detection | detection |
| Level | rate | rate | rate | rate | rate | rate |
| Comparative | 88% | 87% | 94% | 88% | 87% | 93% |
| Example 1 | | | | | | |
| Comparative | 89% | 89% | 94% | 89% | 88% | 93% |
| Example 2 | | | | | | |
| Comparative | 90% | 90% | 94% | 91% | 90% | 94% |
| Example 3 | | | | | | |
| Comparative | 92% | 90% | 94% | 92% | 90% | 94% |
| Example 4 | | | | | | |
| Comparative | 93% | 92% | 95% | 93% | 92% | 94% |
| Example 5 | | | | | | |
| Comparative | 93% | 92% | 95% | 94% | 93% | 95% |
| Example 6 | | | | | | |
| Comparative | 95% | 93% | 95% | 95% | 93% | 95% |
| Example 7 | | | | | | |
| Comparative | 95% | 93% | 95% | 95% | 94% | 95% |
| Example 8 | | | | | | |
| Example 1 | 97% | 98% | 96% | 97% | 98% | 96% |
| Example 2 | 98% | 98% | 98% | 98% | 98% | 98% |
| Example 3 | 97% | 96% | 97% | 98% | 97% | 97% |
| Example 4 | 98% | 97% | 96% | 98% | 97% | 96% |
| Comparative | 93% | 91% | 94% | 95% | 92% | 94% |
| Example 9 | | | | | | |
| Comparative | 95% | 93% | 95% | 95% | 93% | 95% |
| Example 10 | | | | | | |
| Comparative | 95% | 93% | 95% | 95% | 93% | 95% |
| Example 11 | | | | | | |
| Example 5 | 96% | 97% | 96% | 97% | 98% | 96% |
| Example 6 | 98% | 99% | 98% | 97% | 96% | 96% |
| Example 7 | 98% | 97% | 98% | 98% | 97% | 98% |
| Example 8 | 99% | 98% | 97% | 98% | 98% | 97% |
| Example 9 | 97% | 98% | 97% | 96% | 98% | 97% |
| Example 10 | 96% | 96% | 96% | 96% | 96% | 96% |
| Comparative | 95% | 94% | 94% | 94% | 93% | 94% |
| Example 12 | | | | | | |
| Comparative | 94% | 93% | 94% | 94% | 93% | 94% |
| Example 13 | | | | | | |
| Comparative | 92% | 93% | 94% | 92% | 93% | 94% |
| Example 14 | | | | | | |
| Example 11 | 97% | 969 | 96% | 98% | 97% | 98% |
| Example 12 | 99% | 98% | 96% | 97% | 98% | 97% |
| Example 13 | 99% | 98% | 97% | 96% | 98% | 97% |
| Example 14 | 98% | 99% | 98% | 97% | 98% | 97% |
| Example 15 | 96% | 97% | 97% | 96% | 96% | 96% |
| Comparative | 94% | 93% | 94% | 93% | 94% | 94% |
| Example 15 | | | | | | |
| Comparative | 93% | 94% | 94% | 93% | 94% | 94% |
| Example 16 | | | | | | |
| Comparative | 93% | 94% | 94% | 93% | 94% | 94% |
| Example 17 | | | | | | |
| Comparative | 93% | 94% | 95% | 93% | 94% | 95% |
| Example 18 | | | | | | |
| Comparative | 93% | 94% | 95% | 92% | 93% | 95% |
| Example 19 | | | | | | |
| Comparative | 93% | 94% | 94% | 93% | 93% | 94% |
| Example 20 | | | | | | |
| Comparative | 92% | 93% | 94% | 92% | 92% | 93% |
| Example 21 | | | | | | |

TABLE 2A

| | Firing | Particle | Keeping | Heating | Annealing | | |
|---|---|---|---|---|---|---|---|
| | temperature | size | time | rate | temperature | Content [wt %] | |
| Level | [° C.] | [μm] | [min] | [° C./hr] | [° C.] | V | Mn |
| Comparative | 1,230 | 0.3 | 90 | 80 | 900 | 0.5 | 0.2 |
| Example 22 | | | | | | | |
| Example 2 | 1,230 | 0.3 | 90 | 80 | 700 | 0 | 0.2 |
| Example 16 | 1,230 | 0.3 | 90 | 80 | 600 | 0.3 | 0.22 |
| Comparative | 1,230 | 0.3 | 90 | 80 | 500 | 0.5 | 0.22 |
| Example 23 | | | | | | | |
| Comparative | 1,240 | 0.5 | 90 | 80 | 900 | 0.5 | 0.2 |
| Example 24 | | | | | | | |
| Example 7 | 1,240 | 0.5 | 90 | 80 | 700 | 0 | 0.2 |
| Comparative | 1,240 | 0.5 | 90 | 80 | 500 | 0.5 | 0.22 |
| Example 25 | | | | | | | |
| Comparative | 1,250 | 0.7 | 90 | 80 | 900 | 0.5 | 0.2 |
| Example 26 | | | | | | | |
| Example 12 | 1,250 | 0.7 | 90 | 80 | 700 | 0 | 0.2 |
| Comparative | 1,250 | 0.7 | 90 | 80 | 500 | 0.5 | 0.22 |
| Example 27 | | | | | | | |

TABLE 2B

| | Main surface | | | Side surface | | |
|---|---|---|---|---|---|---|
| | | | Surface | | | Surface |
| | | | roughness | | | roughness |
| | Chroma | Lightness | Ra | Chroma | Lightness | Ra |
| Level | C* | L* | [μm] | C* | L* | [μm] |
| Comparative | 15 | 48 | 0.45 | 15 | 45 | 0.25 |
| Example 22 | | | | | | |
| Example 2 | 8 | 47 | 0.25 | 8 | 46 | 0.26 |
| Example 16 | 8 | 45 | 0.31 | 5 | 44 | 0.24 |
| Comparative | 7 | 45 | 0.24 | 4 | 42 | 0.33 |
| Example 23 | | | | | | |
| Comparative | 13 | 45 | 0.30 | 13 | 41 | 0.28 |
| Example 24 | | | | | | |
| Example 7 | 11 | 43 | 0.24 | 10 | 43 | 0.27 |
| Comparative | 6 | 42 | 0.48 | 4 | 40 | 0.36 |
| Example 25 | | | | | | |
| Comparative | 12 | 42 | 0.28 | 12 | 40 | 0.28 |
| Example 26 | | | | | | |
| Example 12 | 11 | 42 | 0.21 | 10 | 42 | 0.43 |
| Comparative | 5 | 40 | 0.26 | 3 | 38 | 0.36 |
| Example 27 | | | | | | |

TABLE 2C

| | Main surface | | | Side surface | | |
|---|---|---|---|---|---|---|
| | Crack | Scratch | Foreign matter | Crack | Scratch | Foreign matter |
| | detection | detection | detection | detection | detection | detection |
| Level | rate | rate | rate | rate | rate | rate |
| Comparative | 98% | 98% | 91% | 97% | 98% | 91% |
| Example 22 | | | | | | |
| Example 2 | 98% | 98% | 98% | 98% | 98% | 98% |
| Example 16 | 98% | 97% | 96% | 97% | 95% | 96% |
| Comparative | 98% | 97% | 93% | 98% | 97% | 93% |
| Example 23 | | | | | | |
| Comparative | 98% | 98% | 92% | 98% | 97% | 91% |
| Example 24 | | | | | | |
| Example 7 | 98% | 97% | 98% | 98% | 97% | 98% |
| Comparative | 98% | 98% | 91% | 98% | 98% | 91% |
| Example 25 | | | | | | |
| Comparative | 98% | 97% | 92% | 98% | 97% | 91% |
| Example 26 | | | | | | |
| Example 12 | 99% | 98% | 96% | 97% | 98% | 97% |
| Comparative | 98% | 98% | 90% | 98% | 98% | 90% |
| Example 27 | | | | | | |

TABLE 3A

| | Firing | Particle | Keeping | Heating | Annealing | | |
|---|---|---|---|---|---|---|---|
| | temperature | size | time | rate | temperature | Content [wt %] | |
| Level | [° C.] | [μm] | [min] | [° C./hr] | [° C.] | V | Mn |
| Example 17 | 1230 | 0.3 | 90 | 80 | 700 | 0 | 0.2 |
| Example 2 | 1230 | 0.3 | 90 | 80 | 700 | 0 | 0.2 |
| Example 18 | 1230 | 0.3 | 90 | 80 | 700 | 0 | 0.2 |

TABLE 3B

| | Main surface | | | Side surface | | |
|---|---|---|---|---|---|---|
| | | | Surface | | | Surface |
| | | | roughness | | | roughness |
| | Chroma | Lightness | Ra | Chroma | Lightness | Ra |
| Level | C* | L* | [μm] | C* | L* | [μm] |
| Example 17 | 8 | 49 | 0.07 | 8 | 48 | 0.07 |
| Example 2 | 8 | 47 | 0.25 | 8 | 46 | 0.26 |
| Example 18 | 8 | 45 | 0.56 | 8 | 45 | 0.56 |

TABLE 3C

| | Main surface | | | Side surface | | |
|---|---|---|---|---|---|---|
| | Crack | Scratch | Foreign matter | Crack | Scratch | Foreign matter |
| | detection | detection | detection | detection | detection | detection |
| Level | rate | rate | rate | rate | rate | rate |
| Example 17 | 97% | 97% | 98% | 97% | 98% | 97% |
| Example 2 | 98% | 98% | 98% | 98% | 98% | 98% |
| Example 18 | 97% | 98% | 97% | 98% | 97% | 98% |

### REFERENCE NUMERALS

1 . . . multilayer ceramic capacitor (dielectric ceramic electronic device)
2 . . . inner dielectric layer
2a . . . outer dielectric layer
2b . . . margin portion
3 . . . internal electrode layer
4 . . . element body (ceramic sintered body)
4a . . . end surface
4b . . . main surface
4c . . . side surface
6 . . . external electrode

What is claimed is:

1. A dielectric ceramic electronic device comprising:
a ceramic sintered body having a surface at least partly comprising a dielectric,
wherein the surface of the ceramic sintered body has a base color with a chroma C*
value in a range of 5 to 11 and a lightness L* value in a range of 38 to 50.

2. The dielectric ceramic electronic device according to claim 1, wherein the surface of the ceramic sintered body has a surface roughness Ra in a range of 0.07 to 0.56.

3. The dielectric ceramic electronic device according to claim 1, wherein
the ceramic sintered body comprises electrode layers and dielectric layers inside,
the electrode layers and the dielectric layers being alternately laminated;
surfaces of the ceramic sintered body comprise main surfaces facing each other along a lamination direction of the electrode layers and side surfaces meeting the main surfaces substantially perpendicularly;
the lightness L* value of the base color of the main surfaces is in a range of 40 to 50 whereas the lightness L* value of the base color of the side surfaces is in a range of 38 to 48; and
the chroma C* value of the base color of the main surfaces is in a range of 8 to 11 whereas the chroma C* value of the base color of the side surfaces is in a range of 8 to 10.

4. The dielectric ceramic electronic device according to claim 1, wherein
the ceramic sintered body comprises electrode layers and dielectric layers inside,
the electrode layers and the dielectric layers being alternately laminated;
surfaces of the ceramic sintered body comprise main surfaces facing each other along a lamination direction of the electrode layers and side surfaces meeting the main surfaces substantially perpendicularly;
the lightness L* value of the base color of the main surfaces is not less than that of the side surfaces; and
the chroma C* value of the base color of the main surfaces is not less than that of the side surfaces.
